(19) United States
(12) Patent Application Publication
(10) Pub. No.: US 2013/0107960 A1
(43) Pub. Date: May 2, 2013

(54) SCENE DEPENDENT MOTION SEARCH RANGE ADAPTATION

(71) Applicant: Syed Ali, Richmond Hill (CA)

(72) Inventor: Syed Ali, Richmond Hill (CA)

(21) Appl. No.: 13/287,462

(22) Filed: Nov. 2, 2011

(51) Int. Cl. H04N 7/28

(52) U.S. Cl. 375/240.16; 375/E07.119

(57) ABSTRACT

Techniques are disclosed relating to scene dependent motion search range adaptation. A search range for a next frame of a video may be modified based on statistical information. Statistical information may include sizes of motion vectors for the current frame. In some embodiments, statistical information may include a histogram with each point on the histogram representing a motion vector size frequency based on the current frame motion vectors. The distribution of the histogram may be used to determine a ratio that may be used to modify the search range for the next frame.

### BACKGROUND

1. Technical Field

This disclosure relates generally to video encoding, and, more specifically, to motion estimation.

2. Description of the Related Art

Performance of a video encoder can be thought of as a point in a three-dimensional space. The three axes represent quality (e.g., peak signal-to-noise ratio (PSNR) or other metrics), size of the encoded result (e.g., compression ratio), and time (e.g., effort or encoder speed). In general, if an encoder gains performance in one of the three dimensions, performance suffers in another one. For example, to improve picture quality in a given encoder, either encoding would need to be performed using better (e.g., lower) quantizers thereby increasing size of the encoding or using laborious methods (e.g., would use all possible combinations to find the most profitable one in terms of quality) thereby increasing the time (and decreasing the speed) to perform the encoding.

### SUMMARY OF EMBODIMENTS

This disclosure describes techniques and structures that facilitate scene dependent motion search range adaptation. In one embodiment, a current frame may be encoded by determining a plurality of motion vectors for the current frame. Statistical information regarding sizes of the determined motion vectors may be generated. The search range of a next frame may be modified based on the generated statistical information.

In one embodiment, generating statistical information regarding sizes of the determined motion vectors may include generating a histogram that includes a number of points. Each point of the histogram may represent a motion vector size frequency based on the determined motion vectors for the current frame. In some embodiments, the statistical information may be analyzed by determining a ratio of a first portion and a second portion of the histogram. Modifying the search range of the next frame may be based on the determined ratio.

### BRIEF DESCRIPTION OF THE DRAWINGS

A better understanding of embodiments of the invention can be obtained when the following detailed description is considered in conjunction with the following drawings, in which:

FIG. 1 is a block diagram illustrating one embodiment of an exemplary system configured to perform motion search range adaptation

FIG. 2 is a block diagram illustrating one embodiment of an encoder configured to perform motion search range adaptation.

FIG. 3 is a flowchart illustrating one embodiment of a method for performing motion search adaptation.

FIG. 4 is a diagram of example search ranges of a macroblock being motion estimated within a frame, according to some embodiments.

FIG. 5 is an example of a histogram of motion vectors in a frame, according to some embodiments.

FIGS. 6a-6c illustrate a comparison of speed, quality, and size between the motion search range adaption according to some embodiments and a fixed search range, for a mixed case of scene motion.

FIGS. 7a-7c illustrate a comparison of speed, quality, and size between the motion search range adaption according to some embodiments and a fixed search range, for a case of low scene motion.

FIGS. 8a-8c illustrate a comparison of speed, quality, and size between the motion search range adaption according to some embodiments and a fixed search range, for a case of high motion and complex texture.

FIG. 9 is a block diagram illustrating one embodiment of an exemplary computer system.

### DETAILED DESCRIPTION

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “An apparatus comprising one or more processor units . . . .” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

First,” “Second,” etc. As used herein, these terms are used as labels for nouns that they precede, and do not imply any type of ordering (e.g., spatial, temporal, logical, etc.). For example, in a video having eight frames, the terms “first” and “second” frames can be used to refer to any two of the eight frames. In other words, the “first” and “second” frames are not limited to logical processing elements 0 and 1.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

In the following discussion, a scene dependent motion search range adaptation is disclosed that allows for dynamic adaptation of motion estimation effort depending on the type and nature of content. The disclosure first describes an exemplary computing device that includes a video encoder, followed by a description of an encoder configured to perform scene dependent motion search range adaptation.

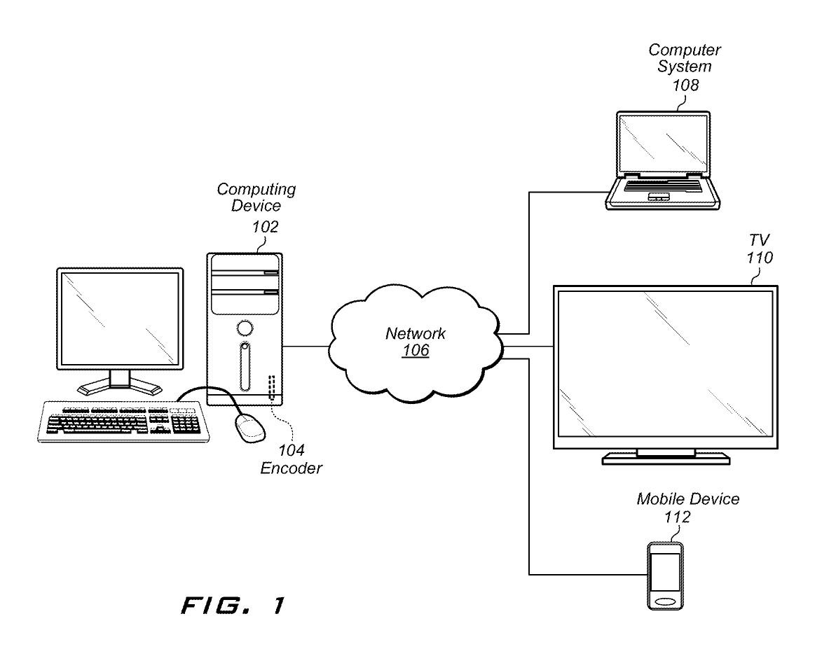

Turning now to FIG. 1, an exemplary device is shown that may include an encoder configured to implement the adaptive search range techniques described herein. As illustrated, computing device 102 may include encoder 104 that is configured to implement the disclosed techniques. As shown, computing device 102 may be a computer. In other embodiments, computing device 102 may be a portable computer (e.g., laptop), personal digital assistant, multimedia player, router, printer, digital camera, gaming system, tablet device, cellular telephone, or television, etc.

In various embodiments, encoder 104 may be implemented in hardware. For example, encoder 104 may be implemented on a graphics processing unit (GPU), as a dedicated video encoder, as a field-programmable gate array (FPGA), an application-specific integrated circuit (ASIC) or other suitable processor. In other embodiments, encoder 104 may be implemented as program instructions executed by a central processing unit (CPU) or other processing unit (including, but not limited to, a DSP, an accelerated processing unit (APU)—e.g., a CPU combined with GPU or DSP and the like). In various embodiments, encoder 104 may be a combination of hardware and software. Encoder 104 may be any type of encoder, such as a block based motion compensated video encoder, a full search encoder, etc. Encoder 104 may implement the disclosed techniques and produce encoded/compressed video. As shown, computing device 102 may output the encoded video to other devices over network 106.

Examples of those other devices may include, for example, computer system 108 (shown as a laptop), TV 110, tablet, set top box, mobile device 112 and the like. Such devices may include decoders (e.g., hardware or software) that are compatible with the encoded video format produced by encoder 104.

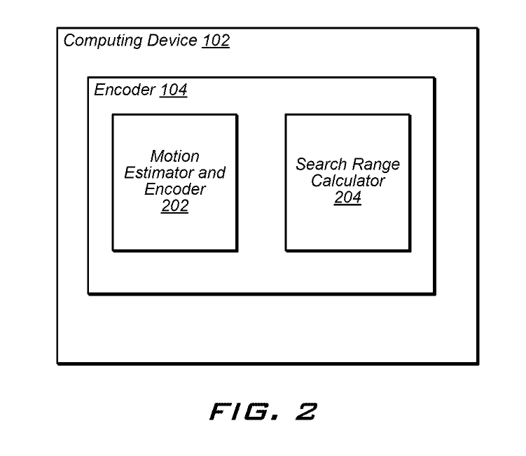

Turning now to FIG. 2, a block diagram is shown illustrating one embodiment of an encoder configured to perform motion search range adaptation. Encoder 104 may include various components. In the illustrated embodiment, encoder 104 includes motion estimator and encoder 202 and search range calculator 204. Not shown, encoder 104 may include on-board memory or memory external to encoder 104 (e.g., memory that is part of computing device 102 memory). Also not shown, encoder 104 may also include various interfaces to interface with other components of computing device 102. In various embodiments, encoder 104 may be implemented on a graphics processing unit (GPU), or in dedicated hardware (e.g., a video encoder, ASIC, or FPGA). In other embodiments, encoder 104 may be implemented as software executed on a CPU of computing device.

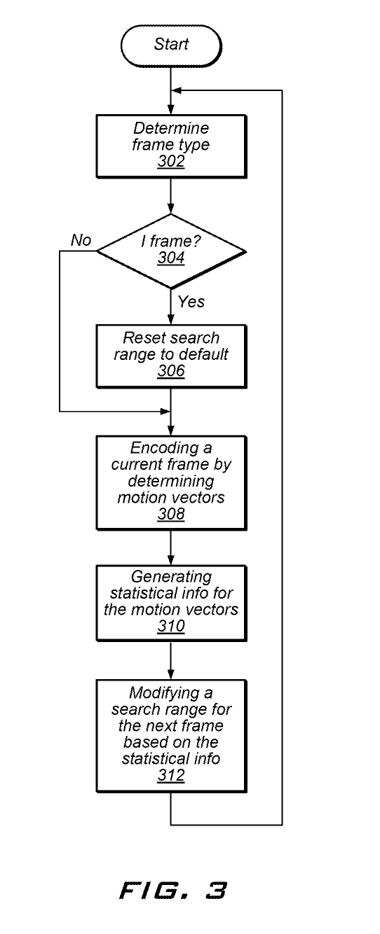

In one embodiment, motion estimator and encoder 202 may be configured to encode a current frame of a video. Encoding a current frame of a video may include determining a number of motion vectors for the current frame. Determining a number of motion vectors for the current frame may include estimating a difference in pixels between the current frame and a previous frame. Motion estimator and encoder 202 may perform motion estimation in a manner such that it respects four boundaries of a search range. For instance, the search range may include left, right, top, and bottom borders, which may be referred to as x_min, x_max, y_min, and y_max, respectively. FIG. 4 shows example search ranges of a macroblock being motion estimated within a frame, according to some embodiments. As shown in FIG. 4, search range 404 includes boundaries x_min, x_max, y_min, and y_max for macroblock 406 being motion estimated within frame 402.

Turning back to FIG. 2, search range calculator 204 may perform search range modifications on each of the four boundaries (x_min, x_max, y_min, and y_max) of a search window based on motion vector statistics for each frame. In other embodiments, various search windows may be used, such as a circle, hexagram, or other geometric regions. The embodiment described herein uses a search rectangle having four boundaries (x_min, x_max, y_min, and y_max).

In one embodiment, search range calculator 204 may modify the four boundaries independent of one another. For example, the update to x_min may be modified (e.g., calculated) separately from x_max, y_min, and y_max. The updated search range may be calculated for the next frame based on motion vector statistics of the present frame. Encoder 104 may also include logic (e.g., motion estimator and encoder 202, search range calculator 204, or some other logic not shown in FIG. 2) that may be configured to detect an I-frame. I-frames may be used to transition from one scene in a video to another scene, which may have very little statistical correlation between the I-frame and the immediately preceding frame. In some embodiments, upon detection of an I-frame, the search range, for each of the four boundaries, may be reset to one or more default values (e.g., (−16,16) for each direction x and y, (−12,12), (−8,8), etc.). Thus, in an embodiment that uses a (−16,16) default value for each direction, x_min may be set to −16 (with respect to some origin), x_max may be set to +16, y_min may be set to −16, and y_max may be set to +16.

In one embodiment, to determine the search range, statistical information regarding sizes of the determined motion vectors for the current frame may be generated and in some embodiments, encoder 104 may save the generated statistical information. In one embodiment, generating statistical information may include generating a histogram (or data that could be used to generate such a histogram); the terms will be used interchangeably throughout. The histogram data may include a plurality of points, with each point representing a motion vector size frequency based on the determined motion vectors for the current frame. Thus, each point on the histogram curve may represent the number of times that a particular motion was found in the scene. In one embodiment, the histogram data may represent the overall frame and the frequency may indicate how many macroblocks have that particular motion. In such an embodiment, at the end of each frame, a histogram may be generated that includes the magnitudes of motion vectors found throughout the whole frame. As such, the histogram may indicate how dynamic the motion is in a given scene (e.g., large amounts of motion, or slow and smooth transitions). An example histogram distribution can be seen in FIG. 5. The example of FIG. 5 represents motion vectors with respect to the x-axis of an example frame. The height of the histogram may represent a quantity of motion vectors at each point from a minimum search range to a maximum search range in a respective dimension, shown as x_min and x_max in FIG. 5. As shown at FIG. 4, x_min and x_max correspond to the leftmost and rightmost portions of the search range in the example shown.

With reference to FIG. 5, search range calculator 204 may use the statistical information in the histogram to modify the search range. The example histogram of FIG. 5 shows areas of the histogram that may be used to calculate x_min but the same or a similar histogram may includes areas that may be used to calculate both directions (horizontal and vertical) and both limits (min and max). In various embodiments, two histograms may be generated, one for the x dimension and one for the y dimension. In one embodiment, search range calculator 204 may calculate the area under the curve in the lower portion of the histogram. This is illustrated in FIG. 5 as the area labeled A. The lower portion of the histogram may be the lower 20%, lower 25%, lower 30% or other portions that are approximately 20-30%. Likewise, the upper portion of the histogram, labeled B, may be the approximately remaining 70-80%. For example, if x_min to x_max is 16 pixels, then the lower portion may be the region within 4 pixels of x_min while the upper region may be the region between 4 and 16 pixels from x_min. Note that lower and upper portions may be used to reflect the areas closest to the current limit. Thus, for the case of x_min as shown in FIG. 5, the lower portion reflects motion vectors that are close to the current limit of x_min while the upper portion reflects motion vectors that are farther from the x_min. Likewise, in an example using y_max, the lower portion reflects motion vectors that are close to the current limit of y_max while the upper portion reflects motion vectors that are farther from y_max. In some embodiments, the histogram division into portions may be determined by heuristics, which can be changed on the fly.

In various embodiments, search range calculator 204 may modify the search range of a next frame based on the generated statistical information. In one embodiment, search range calculator 204 may determine a ratio of a first portion and a second portion of the generated histogram. The ratio may be the ratio of the area under the entire histogram (A+B) to the area under the curve in the lower portion, A (e.g., lower 25%). The ratio may represent a value indicating a farness or closeness of motion vectors of the current frame to the current limit (e.g., x_min in the example shown in FIG. 5). For example, in one embodiment, a large ratio may indicate that the current search range is too large and should be reduced for that direction and limit. Similarly, a small ratio may indicate that the current search range is too small and should be increased for that direction and limit. The calculated ratio may be checked against threshold values, which may be programmable. For example, in one embodiment, the calculated ratio may be checked against two threshold values. As a result of checking the ratio against two threshold values, the search range for that particular direction and limit (e.g., x_min) may be reduced, enlarged, or may remain the same. One threshold value may be a decrease threshold while another may be an increase threshold. For example, if the ratio is above a decrease threshold (e.g., 13, 15, 17, etc.), the search range may be reduced after checking it against a lower bound limit value. The lower bound limit value may represent the farthest the search window is allowed to go in a direction of an axis (e.g., edge of the frame, a number of pixels from an origin within the frame (e.g., −16 pixels from the horizontal center for x_min), etc.). If the ratio is below an increase threshold (e.g., 3, 5, 7, etc.), the search range may be increased after checking it against an upper bound limit value. As is the case with the lower bound, the upper bound limit value may represent the farthest the search window is allow to go in another direction of an axis (e.g., edge of the frame, a number of pixels from an origin within the frame (e.g., +16 pixels from the vertical center for y_max), etc.). If the ratio falls between the decrease and increase thresholds, the search range for the next frame may remain the same as the search window for the current frame. In various embodiments, if the increase or reduction in the search range would exceed the respective bound limit value, the search range may be set to the respective bound limit value for the next frame. Or, in some embodiment, if the increase or reduction would exceed the respective bound limit value, the search range for the next frame may remain the same for that boundary.

In one embodiment, the increase or decrease in search range size may be by one pixel, two pixels, or some other amount of pixels. The adjustment increment may be different depending on the direction and limit. For example, for vertical search range adjustments, the adjustment amount may be 2 pixels while for horizontal search range adjustments, the adjustment may be 1 pixel. In other embodiments, the adjustment amounts may be the same for horizontal and vertical search range adjustments. In some embodiments, the adjustment amounts may be variable such that the amount of search adjustment may vary depending on the content. For example, for a sharp scene transition that goes from low to high motion, the search range size at the start of the high motion may have been sized for low motion and used a small search window. Based on the histogram, search range calculator 204 may adapt the search range size quicker to match the sharp change in content rather than by incrementing the search range window at a constant rate for each frame in which it is determined that the frame rate should adjust.

Using example numbers, consider a scenario in which the search window at the transition from low motion to high motion was 4 pixels by 4 pixels. Further consider in this example that a search window normally increases or decreases a boundary of the search range by 2 pixels based on the calculated ratio and the threshold values. As the scene transitions from low to high motion, the histogram and calculated ratio may indicate a large difference in motion. In such a scenario, search range calculator 204 may increase the search range in one or more directions and/or limit by more than the typical 2 pixels. For example, the histogram and calculated ratio may indicate a large difference in motion in the y_max boundary (e.g., the calculated ratio may be much smaller than the increase threshold). Thus, in one embodiment, the search range may increase by 10 pixels in the y_max direction for the next frame to attempt to arrive at an appropriate sized search window quicker than if the search range were increased at a smaller and same value from frame to frame. For the next frame, the calculated ratio may be larger than much may still be smaller than the increase threshold. Accordingly, for the next frame, the search range may be increased by 4 pixels instead of 10 pixels, which may represent a search range that is closing in on an appropriately sized search range (for that boundary) for the motion in the frame. In such an embodiment, not only may the search range be adaptable from frame to frame but it may also flexibly adapt such that quicker convergence may be achieved.

In one embodiment, encoder 104 may determine the type of frame. For example, encoder 104 may determine that a frame is an intracoded-frame (I-frame), or an interpredicted frame (e.g., bi-predictive picture frame (B-frame) or predicted picture frame (P-frame)). In one embodiment, if encoder 104 determines that a frame is an I-frame, search range calculator 204 may reset the search range to one or more default values. The default value may include default values for each direction and limit (e.g., x_min, x_max, y_min, y_max). If encoder 104 determines that the frame is not an I-frame, then motion estimator and encoder 202 and search range calculator 204 may perform the disclosed techniques to adapt the search range for the next frame. In various embodiments, if the frame is a B-frame, then the search forward and search backward may use different search ranges, or one of the search ranges may be used in both directions (e.g., the larger search range).

In various embodiments, the adaptive search range technique described herein may occur at the frame level per frame, at the macroblock level or for each of a plurality of groupings of macroblocks that collectively make up the frame. As an example, the current frame may be encoded by determining a number of motion vectors of the current frame, statistical information regarding sizes of the determined motion vectors for the current frame may be generated, and the search range for the next frame may be modified based on the generated statistical information at the macroblock level or for groupings of macroblocks.

By implementing an encoder that is configured to perform the disclosed content-dependent, adaptive search range techniques, improvements in the time/speed dimension may be achieved by reducing the search range of motion vectors without compromising the other two metrics (e.g., quality and compression ratio). By doing so, effort spent on motion estimation may be saved.

Turning now to FIG. 3, one embodiment for performing motion search adaptation is shown. While the blocks are shown in a particular order for ease of understanding, other orders may be used. In some embodiments, the method of FIG. 3 may include additional (or fewer) blocks than shown.

At 302, a frame type may be determined. For example, the frame type may be an I-frame, B-frame, or a P-frame.

As shown at 304, if the determined frame is an I-frame, the method may proceed to block 306. If the determined frame type is not an I-frame (e.g., a P-frame), the method may skip block 306 and proceed to block 308.

As illustrated at 306, the search range may be reset to default. For example, the search range for each direction and limit (e.g., x_min, x_max, y_min, y_max) may be reset to a default value. In one embodiment, the default value may be result in a 32 pixel by 32 pixel search range. The search range may be reset to default values for the search range corresponding to each macroblock or grouping of macroblocks.

At 308, a current frame may be encoded by determining a plurality of motion vectors for the current frame. Determining the plurality of motion vectors for the current frame may include estimating a difference in pixels between the current frame and a previous frame.

As shown at 310, statistical information regarding sizes of the determined motion vectors for the current frame may be generated. Generating statistical information regarding sizes of the determined motion vectors may include generating a histogram. The histogram may include a number of points where each point represents a motion vector size frequency based on the determined motion vectors for the frame. The statistical information may be analyzed by determining a ratio of first and second portions of the generated histogram. For example, the ratio may be the total area of both portions of the histogram divided by the area of the first portion. In one embodiment, the first portion may be approximately 25% (e.g., approximately 20-30%) of the area under the histogram and the second portion may be the remaining area under the histogram. In one embodiment, a histogram may be generated for each axis (e.g., x, y, etc.)

As illustrated at 312, the search range for the next frame may be modified based on the generated statistical information. In one embodiment, the search range may be modified based on the determined ratio. For example, the determined ratio may indicate that a given boundary of the search range (e.g., x_min) should be reduced, enlarged, or remain the same. In some embodiments, the determination to reduce, enlarge, or not modify the limit may be based on the determined ratio as compared to one or more threshold values. For instance, if the determined ratio falls above a decrease threshold value, the search range may be reduced. Modification of the search range may also factor in an absolute lower or upper bound. In the previous example, where the determined ratio may fall above a decrease threshold value, a reduction in the search range may cause that limit to cross a lower bound. In such an example, the limit may be set to the lower bound, or the limit may remain the same in various embodiments. In some embodiments, the modification of the search range for a limit may vary from frame to frame. For example, the modification of the x_min limit for the search range from the current frame to the next frame may be by 8 pixels while the modification of the x_min limit for the search range from the next frame to the subsequent next frame may be by 2 pixels. Thus, the modification may be by a different amount from frame to frame. In one embodiment, the modification of the search range may be performed separately for each boundary (e.g., x_min, x_max, y_min, y_max) of the search range.

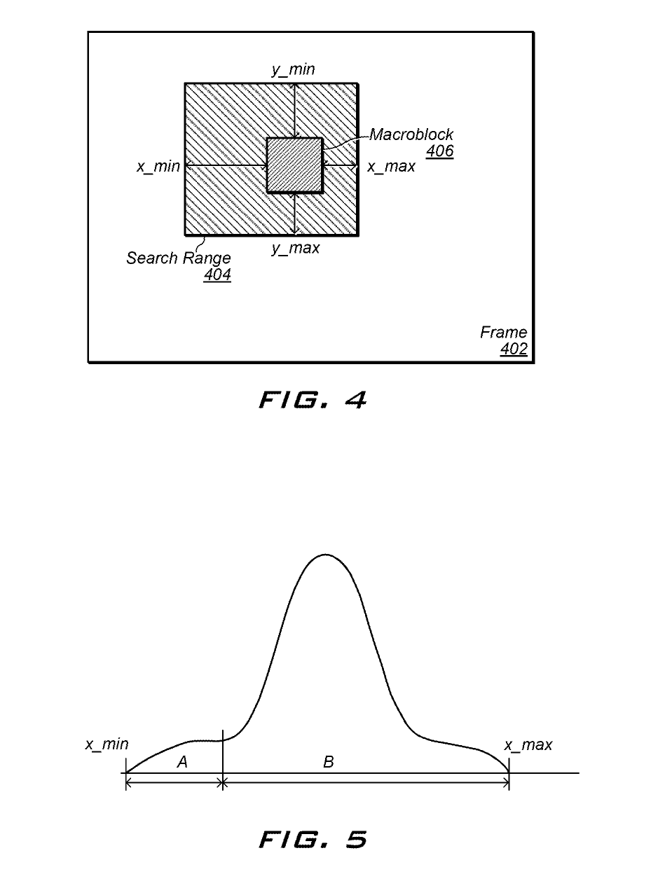

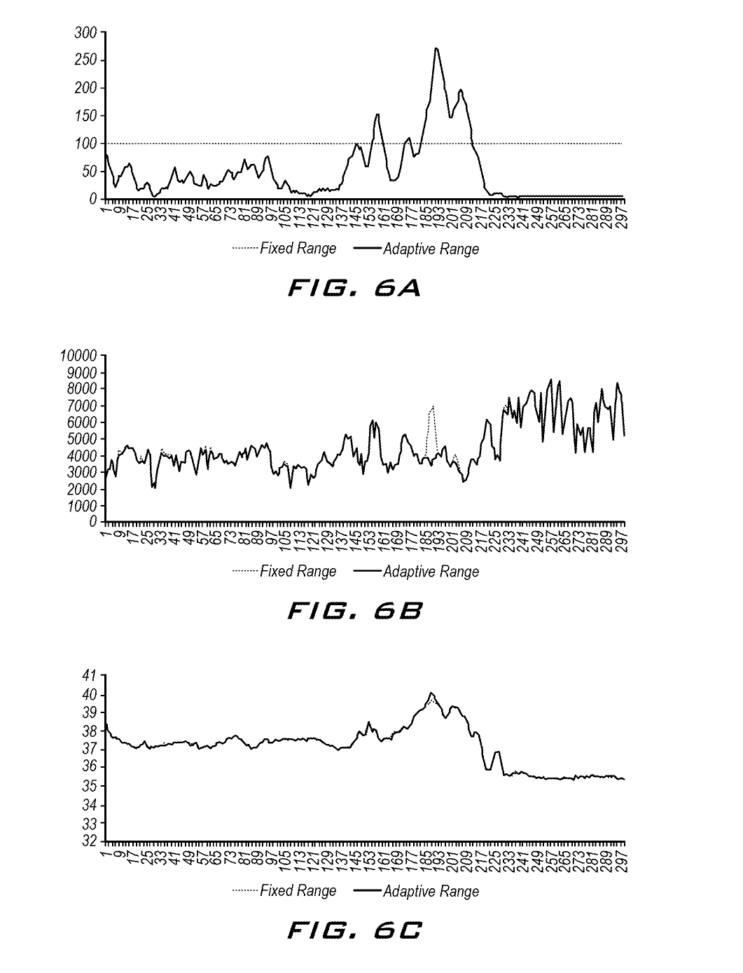

FIGS. 6a-6c, 7a-7c, and 8a-8c illustrate a comparison of speed, quality, and size between a fixed search range and an adaptive motion search range, according to some embodiments, for three different scenes. The fixed search range encoding and adaptive motion search range encoding were implemented on the same MPEG-4 encoder, using the same encoding parameters for better comparison sake. Thus, there were no variations in the process for testing the two search range implementations; for example, the same motion estimator (full search) was used for both cases and the quantizer was kept at a fixed value (QP=5) for both as well. Accordingly, the sole difference between the two encoding sessions is that one keeps the search range fixed (at −16 to +16 for both horizontal and vertical) whereas the other uses the disclosed search range adaptation techniques allowing the search range to follow the motion trends as the sequence moves along. For both a fixed search range and adaptive search range, FIGS. 6a, 7a, and 8a illustrate the number of searches performed for the entire frame, with the Y-axis representing the percentage effort compared to a (−16,+16) search range. FIGS. 6b, 7b, and 8b illustrate the PSNR, which shows the comparison from the original uncompressed sequence to the fixed search range and adaptive search range encodings and may represent the quality of the encodings. FIGS. 6c, 7c, and 8c illustrate the number of bytes produced for each frame for both the fixed search range and adaptive search range, which may represent the size or compression ratio for the encodings.

FIGS. 6a-6c illustrate a comparison of speed, quality, and size between the disclosed motion search range adaption and a fixed search range, for a mixed case of scene motion. For example, the scene was shot with a hand-held camera and contains a small amount of global motion throughout the sequence. The sequence begins with little motion, is followed by a large motion (e.g., pan), and then settles to little or no motion. As shown in FIG. 6a, the Y-axis represents the percentage effort for motion estimation with a fixed range being the baseline at 100%. The X-axis represents the number of searches performed for the entire frame. As shown, for many of the searches, the adaptive search range implementation is more efficient, at times reducing the motion estimation effort to around 5% of the fixed range implementation motion estimation effort. At a few points in FIG. 6a (e.g., from about frame 150 to 160, near frame 170, and from about frame 180-210) the adaptive search range may expand beyond the fixed range (−16, 16). As shown in FIGS. 6b-6c, though, the increased search range for those points may result in increased quality and/or decreased encoding size. In some embodiments, though, the range extension may be capped with a maximum search range threshold. For example, the maximum adaptive search range may be capped at (−16, 16) such that in this example, the motion estimation effort for the adaptive search range would be at or below the fixed range motion estimation effort for each of the searches.

FIG. 6b illustrates a frame size in bytes on the y-axis and searches on the x-axis. As shown, no significant size difference exists between the frames produced by the two encodings, even in areas with very low search effort in the adaptive search range encoding. When the adaptive search range expands the search range (e.g., from around frame 180 to 200), however, smaller frames (nearly half the size) are produced for the adaptive search range encoding than the fixed range encoding. Smaller frames may be possible by more accurate block matches in the adaptive search range encoding. The PSNR graph in FIG. 6c confirms that no quality loss is suffered by using the adaptive search range encoding, even when the adaptive search range encoding is working at only 5% motion estimation load. In other parts, where the search range was adapted beyond the fixed range, the quality of the encoded frame was even increased.

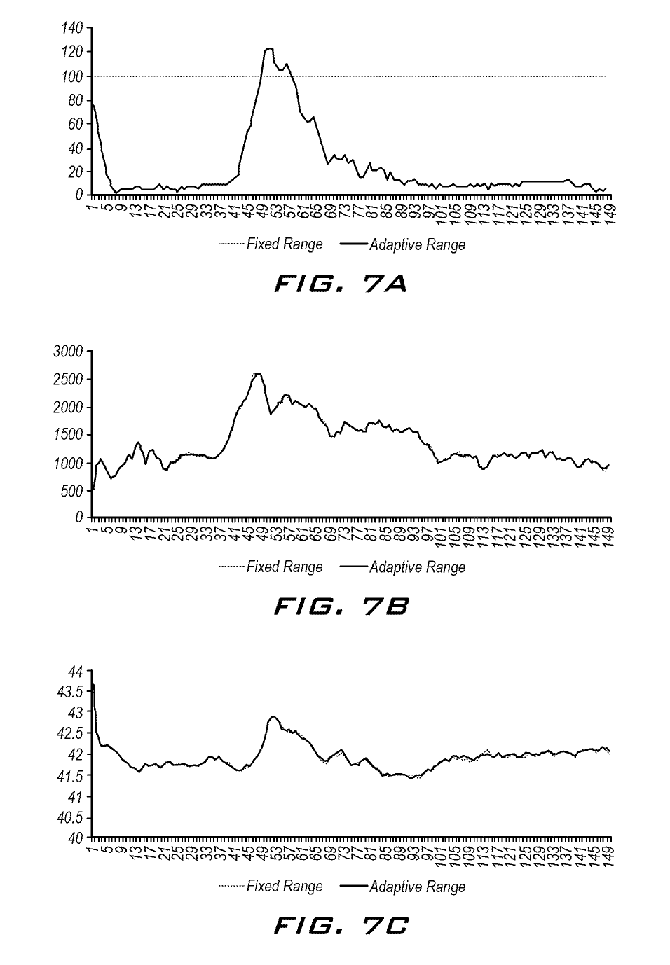

FIGS. 7a-7c illustrate a comparison of speed, quality, and size between the disclosed motion search range adaption and a fixed search range, for a case of low scene motion (e.g., to represent low bandwidth telecom scenarios). FIG. 7a shows that the adaptive search range quickly narrows to the low motion content. The adaptive search range modeled in this example implemented a minimum search range of (−2, +2) for each direction, which was reached by the 7^{th} frame. The reduction to the minimum search range represents 3% of the effort as a percentage of effort compared to the fixed range encoding. As seen in FIG. 7a, at the point where the scene motion picks up, the adaptive search range adjusts to that increased scene motion. As in FIG. 6b, FIG. 7b shows that no loss of encoding efficiency results from the lowered search range of the adaptive search range encoding. Likewise, the PSNR graph of FIG. 7c shows that no loss of quality results from the lower search range for the same quantizer value.

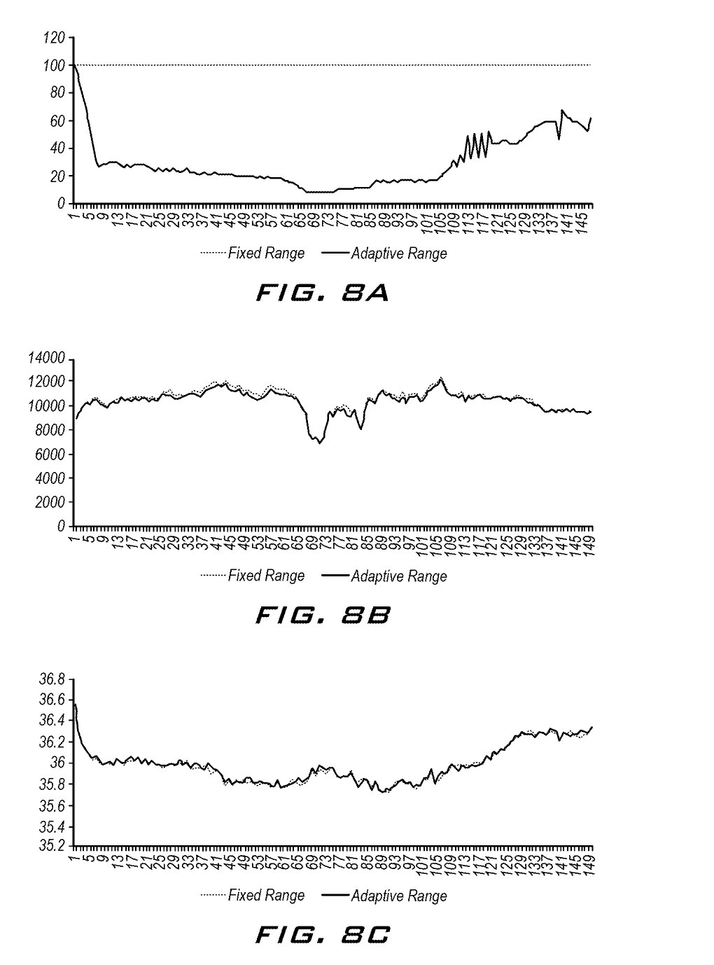

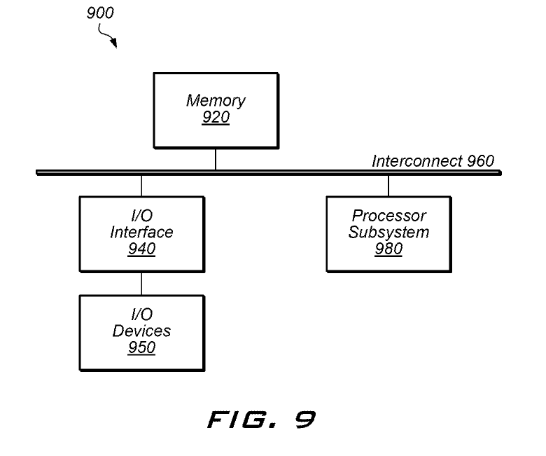

FIGS. 8a-8c illustrate a comparison of speed, quality, and size between the motion search range adaption according to some embodiments and a fixed search range, for a case of high motion and complex texture. For example, the scene used in generating these results was a scene in which a large part of the scene (background) has some global motion (pan) whereas a significant part (a bus) remains substantially stationary in the middle of the screen. As seen in FIG. 8a, the adaptive search range drops to around 9% motion effort of the fixed range. Generally, as was the case in FIGS. 6a-7c, the adaptive algorithm produced a smaller frame size for the same quality using less search range as shown in FIGS. 8b-8c.

### Exemplary Computer System

Turning now to FIG. 9, one embodiment of an exemplary computer system 900, which may include encoder 104, is depicted. Computer system 900 includes a processor subsystem 980 that is coupled to a system memory 920 and I/O interfaces(s) 940 via an interconnect 960 (e.g., a system bus). I/O interface(s) 940 is coupled to one or more I/O devices 950. Computer system 900 may be any of various types of devices, including, but not limited to, a server system, personal computer system, desktop computer, laptop or notebook computer, mainframe computer system, handheld computer, workstation, network computer, a consumer device such as a mobile phone, pager, or personal data assistant (PDA). Computer system 900 may also be any type of networked peripheral device such as storage devices, switches, modems, routers, etc. Although a single computer system 900 is shown for convenience, system 900 may also be implemented as two or more computer systems operating together.

Processor subsystem 980 may include one or more processors or processing units. For example, processor subsystem 980 may include one or more processing units (each of which may have multiple processing elements or cores) that are coupled to one or more resource control processing elements 920. In various embodiments of computer system 900, multiple instances of processor subsystem 980 may be coupled to interconnect 960. In various embodiments, processor subsystem 980 (or each processor unit or processing element within 980) may contain a cache or other form of on-board memory. In one embodiment, processor subsystem 980 may include processor 10 described above.

System memory 920 is usable by processor subsystem 980. System memory 920 may be implemented using different physical memory media, such as hard disk storage, floppy disk storage, removable disk storage, flash memory, random access memory (RAM—static RAM (SRAM), extended data out (EDO) RAM, synchronous dynamic RAM (SDRAM), double data rate (DDR) SDRAM, RAMBUS RAM, etc.), read only memory (ROM—programmable ROM (PROM), electrically erasable programmable ROM (EEPROM), etc.), and so on. Memory in computer system 900 is not limited to primary storage such as memory 920. Rather, computer system 900 may also include other forms of storage such as cache memory in processor subsystem 980 and secondary storage on I/O Devices 950 (e.g., a hard drive, storage array, etc.). In some embodiments, these other forms of storage may also store program instructions executable by processor subsystem 980.

I/O interfaces 940 may be any of various types of interfaces configured to couple to and communicate with other devices, according to various embodiments. In one embodiment, I/O interface 940 is a bridge chip (e.g., Southbridge) from a front-side to one or more back-side buses. I/O interfaces 940 may be coupled to one or more I/O devices 950 via one or more corresponding buses or other interfaces. Examples of I/O devices include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 900 is coupled to a network via a network interface device.

Program instructions that are executed by computer systems (e.g., computer system 900) may be stored on various forms of computer readable storage media. Generally speaking, a computer readable storage medium may include any non-transitory/tangible storage media readable by a computer to provide instructions and/or data to the computer. For example, a computer readable storage medium may include storage media such as magnetic or optical media, e.g., disk (fixed or removable), tape, CD-ROM, or DVD-ROM, CD-R, CD-RW, DVD-R, DVD-RW, or Blu-Ray. Storage media may further include volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media may include microelectromechanical systems (MEMS), as well as storage media accessible via a communication medium such as a network and/or a wireless link.

In some embodiments, a computer-readable storage medium can be used to store instructions read by a program and used, directly or indirectly, to fabricate hardware for encoder 104 described above. For example, the instructions may outline one or more data structures describing a behavioral-level or register-transfer level (RTL) description of the hardware functionality in a high level design language (HDL) such as Verilog or VHDL. The description may be read by a synthesis tool, which may synthesize the description to produce a netlist. The netlist may comprise a set of gates (e.g., defined in a synthesis library), which represent the functionality of encoder 104. The netlist may then be placed and routed to produce a data set describing geometric shapes to be applied to masks. The masks may then be used in various semiconductor fabrication steps to produce a semiconductor circuit or circuits corresponding to encoder 104.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
encoding a current frame by determining a plurality of motion vectors for the current frame; and
modifying a search range of a next frame based on statistical information regarding sizes of the determined motion vectors for the current frame.

2. The method of claim 1, wherein said generating the statistical information regarding size of the determined motion vectors for the current frame includes generating a histogram comprising a plurality of points, wherein each point of the plurality of points represents a motion vector size frequency based on the determined motion vectors for the current frame.

3. The method of claim 2, further comprising analyzing the statistical information by determining a ratio of a first portion and a second portion of the generated histogram, wherein said modifying is performed based on the ratio.

4. The method of claim 3, wherein the first portion comprises approximately 25% of a total area under the histogram and wherein the second portion comprises approximately 75% of the total area under the histogram.

5. The method of claim 1, further comprising:
determining that the next frame is not an I-frame type frame; and
performing said modifying a search range of a subsequent next frame based on said encoding for the next frame.

6. The method of claim 5, wherein said modifying the search range of the subsequent next frame is by a different amount than said modifying the search range of the next frame.

7. The method of claim 1, further comprising:
determining that the next frame is not an I-frame type frame;
performing said encoding and generating for the next frame;
determining that modifying a search range of a subsequent next frame based on statistical information regarding sizes of the determined motion vectors for the next frame would exceed a bound limit value of the search range; and
setting the search range of the subsequent next frame to the bound limit value.

8. The method of claim 1, wherein said encoding and modifying is performed separately for a minimum boundary and for a maximum boundary for each of a plurality of axes.

9. The method of claim 1, further comprising:
determining that the next frame is an I-frame type frame;
setting the search range of the next frame to a default value; and
encoding the next frame by determining a plurality of motion vectors for the next frame.

10. The method of claim 1, wherein said encoding and modifying is performed for each of a plurality of groupings of one or more macroblocks, wherein the plurality of groupings comprise the first frame.

11. The method of claim 1, wherein said determining includes estimating a difference in pixels between the current frame and a previous frame.

12. The method of claim 1, further comprising generating the statistical information regarding sizes of the determined motion vectors for the current frame.

13. An apparatus, comprising:
an encoder configured to:
encode a current frame by determining a plurality of motion vectors for the current frame,
generate statistical information regarding sizes of the determined motion vectors for the current frame; and
modify a search range of a next frame based on the statistical information regarding sizes of the determined motion vectors for the current frame.

14. The apparatus of claim 13, wherein said generating statistical information regarding size of the determined motion vectors for the current frame includes generating a histogram comprising a plurality of points, wherein each point of the plurality of points represents a motion vector size frequency based on the determined motion vectors for the current frame.

15. The apparatus of claim 14, wherein the encoder is further configured to analyze the statistical information by determining a ratio of a first portion and a second portion of the generated histogram, wherein said modifying is performed based on the ratio.

16. The apparatus of claim 13, wherein said encoding, determining, and modifying is performed separately for a minimum boundary and for a maximum boundary for each of a plurality of axes.

17. The apparatus of claim 13, wherein the encoder is further configured to:
determine that the next frame is an I-frame type frame; and
set the search range of the next frame to a default value.

18. The apparatus of claim 13, wherein the encoder is further configured to:
determine that the next frame is not an I-frame type frame; and
perform said modifying a search range of a subsequent next frame based on said encoding and said generating for the next frame

19. The apparatus of claim 18, wherein said modifying the search range of the subsequent next frame is by a different amount than said modifying the search range of the next frame.

20. A computer readable storage medium comprising a data structure which is operated upon by a program executable on a computer system, the program operating on the data structure to perform a portion of a process to fabricate an integrated circuit including circuitry described by the data structure, the circuitry described in the data structure including:
encoding a current frame by determining a plurality of motion vectors for the current frame,
generating statistical information regarding sizes of the determined motion vectors for the current frame; and
modifying a search range of a next frame based on the statistical information regarding sizes of the determined motion vectors for the current frame.

21. The computer readable storage medium of 19, wherein the storage medium stores hardware description language (HDL) data, Verilog data, or graphic database system II (GDSII) data.

22. An encoded video data stream generated by a process comprising:
encoding a current frame by determining a plurality of motion vectors for the current frame; and
modifying a search range of a next frame based on statistical information regarding sizes of the determined motion vectors for the current frame.
